(19) United States
(12) Patent Application Publication
(10) Pub. No.: US 2008/0122600 A1
(43) Pub. Date: May 29, 2008

(54) Sensor, Designed For Placement In A Series Circuit, In Particular For Application In A Motor Vehicle, A Method For Operating Such Sensors And A Device For Operating Them

(76) Inventors: Matthias Wellhoefer, Stuttgart (DE); Volker Frese, Schwieberdingen (DE)

Correspondence Address: KENYON & KENYON LLP, ONE BROADWAY, NEW YORK, NY, 10004, US

(21) Appl. No.: 11/666,180

(22) PCT Filed: Aug. 3, 2005
(86) PCT No.: PCT/EP05/53805

§ 371 Date: Oct. 29, 2007

(30) Foreign Application Priority Data
Oct. 21, 2004 (DE) 10 2004 051 275.2

(51) Int. Cl. B60Q 11/00

(52) U.S. Cl. 340/436; 340/425.5

(57) ABSTRACT

A sensor designed for peripheral placement in a series circuit, in particular for application in a motor vehicle, has the following components. A sensor element for sampling a certain variable and forming a signal corresponding to the certain variable; an analyzer unit for analyzing and processing the signal of the sensor element, which is connected to the sensor element via a sensor connection; a receiving interface for connection to a second sensor for receiving data transmitted from the second sensor, which is connected to the analyzer unit via an input connection, and a transmitting interface for connection to a further sensor or to a sensor interface of a control unit for transmitting data to the further sensor or to the control unit, the transmitting interface being connected to the analyzer unit via an output connection, the receiving interface and the transmitting interface being designed for an identical hardware and software protocol. A method for operating such sensors and a device for operating them are also described.

### FIELD OF THE INVENTION

The present invention relates to a sensor, designed for placement in a series circuit, in particular for application in a motor vehicle, a method for operating such sensors and a device for operating them.

### BACKGROUND INFORMATION

Different sensors for detecting impact events in motor vehicles have been used for years. Pressure sensors and acceleration sensors known as peripheral sensors are used for detecting side impacts outside of the associated electronic control unit of restraint systems. Acceleration sensors are used as additional peripheral sensors for detecting the impact or crash severity or are used for what is known as offset detection. Several similar sensors are often installed at different points in the motor vehicle serving the same purpose, such as PAS sensors in the A, B, and C columns of a motor vehicle body or pressure sensors in the front and rear doors of the vehicle for detecting side crashes. These sensors are connected to the associated control unit in a known manner for transmitting power and data, e.g., via bus systems for connecting multiple sensors to an interface.

German Patent Publication No. DE 101 14 504, which describes a method for transmission of data between a sensor and a control unit which are connected to one another via a dual-wire line, should be cited for illustration purposes. Both power for the sensor as well as data from the sensor are transmitted via this dual-wire line. This data also contains sensor-specific information such as details about its identification, status, and sensed values.

Present systems are typically relatively inflexible in their configuration and their architecture.

A restraint system is generally designed for one vehicle type and may only be modified or expanded to a limited extent. A bus system must normally also have a suitable configuration. Therefore, more and more peripheral sensors are used in airbag systems. In order to limit the number of terminals on the associated control unit, some automakers request bus systems. For reasons of regulations regarding electromagnetic compatibility (EMC), the data rates of such bus systems are limited. In a conventional design, this also results in a limitation of the data rate for each individual sensor. However, a high data rate is necessary in order to respond quickly enough to crash events, for example.

### SUMMARY OF THE INVENTION

The sensor according to the present invention makes it possible to connect peripheral sensors in a series circuit to a single sensor interface of a control unit and to operate them according to the method according to the present invention.

This has the advantage that the full bandwidth of the physical sensor interface on the control unit may be used, and the data rate of each sensor may be increased vis-à-vis the related art.

The basic idea of the present invention is explained in the following.

The core of the present invention is a peripheral sensor which may be placed in a series circuit together with other sensors of the same design. This is also referred to by the term “cascadable” sensor. A point-to-point interface having the same hardware and software protocol is formed between the control unit and the first sensor and between the other sensors.

An essential advantage of the present invention is that, based on priority information, the respective sensor decides itself which signal it conveys, the signal from the preceding sensor or its own signal.

In this way, high data rates of the individual sensors may advantageously be used. The priority information of the respective signals may additionally be superimposed and thus modified during operation via a further priority criterion such as the signal height.

The sensor according to the present invention is designed for peripheral placement in a series circuit, in particular for application in a motor vehicle, and includes the following components:
a sensor element for sampling a certain variable and forming a signal corresponding to the certain variable;
an analyzer unit, which is connected to the sensor element via a sensor connection, for analyzing and processing the signal of the sensor element;
a receiving interface, which is connected to the analyzer unit via an input connection, for connection to a second sensor for receiving data transmitted by the second sensor, and
a transmitting interface for connection to an additional sensor or to a sensor interface of a control unit for transmitting data to the additional sensor or to the control unit, the transmitting interface being connected to the analyzer unit via an output connection,
the receiving interface and the transmitting interface being designed for an identical hardware and software protocol.

It is thus achieved that an advantageously simple series circuit of peripheral sensors and their subsequent modification and variation are possible.

In a preferred embodiment, the analyzer unit has a selector device for selecting data received by the receiving interface or/and signals received from the sensor element for transmission to the transmitter interface. This is particularly advantageous since it makes simple differentiation of the signals possible.

It is particularly preferred that the selector device is designed for a selection decision from priority information of the data received via the receiving interface and predefinable data for transmission of the data received via the receiving interface or/and data of its own sensor element.

In addition, in a further embodiment, the selector device has a switching device for connecting the input connection or the sensor connection to the output connection and a control unit for controlling the switching device. The signal having the highest priority is thus immediately connected to the transmitting interface for transmission.

In a further embodiment, the selector device has a processing device for data reduction for data received via the receiving interface and for the signals of the sensor element, thereby advantageously expanding the range of use even for limited data rates.

In a further embodiment, the selector device has a memory device for the predefinable data or/and a control input for the selection decision for operating the switching device. The predefinable data may thereby be variably called, i.e., also depending on the operating condition, this also being possible via a control input.

In a further embodiment, the selector device has a further memory device for storing collected received data making temporary storage of certain data quantities possible which are only transmitted after the transmission of data having the highest priority.

A method according to the present invention for operating sensors situated in a series circuit on a control unit, in particular in a motor vehicle, is characterized in that data of a signal of a sensor element is analyzed and priority information is appended to the data according to predefinable data values in each sensor of the series circuit, that data of a sensor connected via a receiving interface is received and priority information of the received data and the data of the sensor element is compared with each other or with predefinable data values in each sensor within the series circuit with the exception of the sensor whose receiving interface has no connection, data being transmitted to a transmitting interface of a sensor connected to the transmitting interface or to a sensor interface of a control unit in the sequence of the priorities, all interfaces being operated with the same hardware and software protocol. It is thereby advantageously ensured that high data rates may also be used, the data having the highest priority being always transmitted.

In a further embodiment, a predefinable data value or a signal height is the priority information. During operation, a signal height may advantageously adapt or modify the predefined priority information according to the instantaneous operating condition, thereby achieving advantageous flexibility.

In a further embodiment, the predefinable data value is modifiable via a control input, thereby making external influencing possible in a simple manner.

It is advantageous for high data rates that, in each case, the data of the sensors is collected in a memory device and subsequently transmitted.

In the case of limited data rates, the data of the sensors is subjected to a data reduction algorithm, whereby an advantageous compression of the data takes place for rapid data transmission.

It is advantageous that in one embodiment transmission of the data and communication of the sensors among each other and with the control unit are executed synchronously or partly asynchronously, in the case of partly asynchronous execution, the last sensor (5) in the series circuit determining the clock rate.

A device according to the present invention having a control unit and a series circuit of sensors is characterized in that a first sensor having a transmitting interface is connected to a sensor interface of a control unit via a first connection, a receiving interface of the first sensor being connected to the transmitting interface of a second sensor via a second connection, and that, via third and fourth connections, additional sensors are connected in series among each other in such a way that the receiving interface of the respective preceding sensor is connected to the transmitting interface of the respective downstream sensor. In this way, an advantageously simple device of a series circuit of cascadable sensors to a single sensor interface of a control unit is made possible.

Advantageous embodiments and refinements of the present invention arise from the subclaims and the description with reference to the drawing.

### BRIEF DESCRIPTION OF THE DRAWINGS

The present invention is explained in greater detail in the following based on the exemplary embodiment shown in the figures of the drawing.

FIG. 1 shows a block diagram of an embodiment of a device according to the present invention having sensors according to the present invention;

FIG. 2 shows a schematic representation of a configuration of a sensor according to the present invention, and

FIG. 3 shows a configuration of a selector device of a sensor according to FIG. 2.

### DETAILED DESCRIPTION

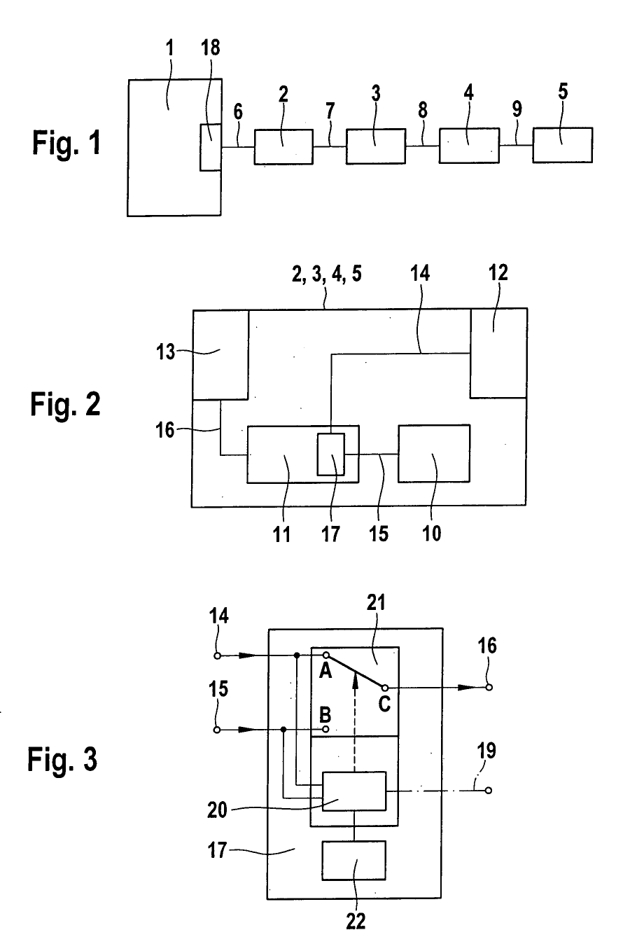

FIG. 1 shows an embodiment of a device according to the present invention having sensors 2 through 5 in a block diagram. These are peripheral sensors 2 through 5 which are installed outside of a control unit 1 in a motor vehicle (not shown). The signals are unidirectionally transmitted, i.e., from a fourth sensor 5 via the preceding sensors 4, 3, 2, to control unit 1.

A first sensor 2 with a sensor interface 18 is initially connected to control unit 1 via a first connection 6. Additional sensors 3, 4, 5, follow in a series circuit: A second sensor 3 is connected to the preceding first sensor 2 via a second connection 7 and to a subsequent third sensor 4 via a third connection 8. In this exemplary embodiment, the series circuit is composed of four sensors 2 through 5, the fourth sensor 5 being connected to the preceding third sensor 4 via a fourth connection 9.

This arrangement of sensors 2 through 5, also referred to as “cascadable,” has connections between certain interfaces of sensors 2 through 5 and control unit 1, which form point-to-point interfaces and are all operated via the same hardware and software protocol. Sensors 2 through 5 are interconnected via internal interfaces which are described with reference to FIG. 2.

FIG. 2 shows a schematic representation of a configuration of such a “cascadable” sensor 2 through 5. Sensor 2 through 5 has the following components: A sensor element 10, an analyzer unit 11 having a selector device 17, a receiving interface 12, and a transmitting interface 13.

Sensor element 10 detects a certain variable, such as pressure or acceleration, and converts it into an electrical sensor signal which is conveyed to analyzer unit 11 via a sensor connection 15. Analyzer unit 11, a special integrated circuit, for example, analyzes the signal of sensor element 10 and, via an input connection 14, receives data from receiving interface 12 of subsequent sensor 3 through 5 connected thereto.

Analyzer unit 11 conveys either the signal received from receiving interface 12 or the signal of sensor element 10 to transmitting interface 13 via an output connection 16 according to a certain selection criterion, either a preceding sensor 2 through 4 or sensor interface 18 of control unit 1 being connected to transmitting interface 13.

A signal is selected in selection device 17 of analyzer unit 11 as a signal to be conveyed, having the highest priority, in this example via priority information. Analyzer unit 11 of subsequent sensor 3 through 5 appends to the data of the respective sensor element 10 priority information which is present as a fixed predefined value in a memory device (see FIG. 3). The preceding selection device 17 thus detects the priority for transmission. If the data of fourth sensor 5 is of the highest priority, e.g., because this sensor 5 has detected a crash, then analyzer unit 11 of fourth sensor 5 adds this criterion to this data and all selection devices 17 of sensors 2 through 4 situated in the series circuit immediately convey this data to control unit 1.

In a further embodiment, the signal height of a sensor signal may also be the priority criterion. If in normal driving operation, for example, only the data of second sensor 3 is transmitted and a crash event suddenly occurs which third sensor 4 detects, then its signal height is substantially greater than that of second sensor 3. Consequently, the signal of third sensor 4, arriving in second sensor 3, is recognized as highest priority due to its signal height and is immediately transmitted.

FIG. 3 shows an exemplary configuration of a selection device 17 of a sensor 2 through 5 according to FIG. 2. In this exemplary embodiment, selection device 17 contains a switching device 21 having contact terminals A, B, and C which are represented as electrical switching symbols for the sake of simplicity. This switching device is operated via a control unit 10 which is indicated by a dashed line. Control unit 10 is connected to input connection 14 and sensor connection 15 in order to sample the priority information of the signals present on these connections. Predefinable data values, which are used for the selection decision between the signals on connections 14 and 15, are stored on a memory device 22 connected to control unit 10. Depending on the selection decision, switching device 21 connects, as a function of control unit 20, contact terminal A, which is connected to input connection 14, to output connection 16 connected to contact terminal C when the signal received from receiving interface 12 shows the highest priority, or it connects contact terminal B to contact terminal C when its own sensor signal shows the highest priority.

Unidirectional transmission in the series circuit according to FIG. 1 may take place synchronously or partly asynchronously. In the asynchronous case, the last sensor in the series circuit, here fourth sensor 5, determines the clock rate. Preceding third sensor 4 waits until data from fourth sensor 5 is delivered. It subsequently transmits this data together with its updated data about further sensors 3 and 2 to control unit 1.

The present invention is not limited to the above-described exemplary embodiments, but rather it is modifiable in many different ways.

So it is conceivable, for example, that in the case of a limited data rate, data reduction algorithms are used in the respective analyzer unit 11 of a sensor 2 through 5.

Furthermore, it is also conceivable that selection device 17 has a control input 19 on its control unit 20 via which external control signals for priority specification or priority change may be input depending on and in accordance with the operating conditions.

List of reference numerals

| | |
|---|---|
| 1 | control unit |
| 2 | first sensor |
| 3 | second sensor |
| 4 | third sensor |
| 5 | fifth sensor |
| 6 | first connection |
| 7 | second connection |
| 8 | third connection |
| 9 | fourth connection |
| 10 | sensor element |
| 11 | analyzer unit |
| 12 | receiving interface |
| 13 | transmitting interface |
| 14 | input connection |
| 15 | sensor connection |
| 16 | output connection |
| 17 | selection device |
| 18 | sensor interface |
| 19 | control input |
| 20 | control unit |
| 21 | switching device |
| 22 | memory device |
| A, B, C | contact terminals |

1-14. (canceled)

15. A sensor for peripheral placement in a series circuit for application in a motor vehicle, comprising:
a sensor element for sampling a certain variable and forming a signal corresponding to the certain variable;
an analyzer unit for analyzing and processing the signal of the sensor element and being connected to the sensor element via a sensor connection;
a receiving interface for connection to a second sensor and for receiving data transmitted from the second sensor, the receiving interface being connected to the analyzer unit via an input connection; and
a transmitting interface for connection to one of a further sensor and a sensor interface of a control unit for transmitting data to one of the further sensor and the control unit, the transmitting interface being connected to the analyzer unit via an output connection, wherein the receiving interface and the transmitting interface are designed for an identical hardware and software protocol.

16. The sensor as recited in claim 15, wherein the analyzer unit includes a selection device for selecting at least one of the data received from the receiving interface and the signals received from the sensor element for transmission to the transmitting interface.

17. The sensor as recited in claim 16, wherein the selection device makes a selection decision from priority information of the data received via the receiving interface and at least one of predefinable data for transmission of the data received via the receiving interface and data of the sensor element.

18. The sensor as recited in claim 17, wherein the selection device includes:
a switching device for connecting one of the input connection and the sensor connection to the output connection, and
a control unit for controlling the switching device.

19. The sensor as recited in claim 18, wherein the selection device includes a processing device for data reduction for data received via the receiving interface and for the signals of the sensor element.

20. The sensor as recited in claim 19, wherein the selection device includes at least one of a memory device for the predefinable data and a control input for the selection decision for operating the switching device.

21. The sensor as recited in one of claim 20, wherein the selection device includes a further memory device for storing collected received data.

22. A method for operating sensors situated in a series circuit on a control unit in a motor vehicle, comprising:
analyzing data of a signal of a sensor element;
appending priority information to the data according to predefinable data values in each sensor of the series circuit;
receiving data of a sensor connected via a receiving interface;
comparing priority information of the received data and the data of the sensor element one of with each other and with predefinable data values in each sensor within the series circuit with the exception of a sensor whose receiving interface has no connection; and
transmitting the data one of to a transmitting interface of a sensor connected to the transmitting interface and to a sensor interface of a control unit in a sequence of priorities, all interfaces being operated with the same hardware and software protocol.

23. The method as recited in claim 22, wherein the priority information is one of a predefinable data value and a signal height.

24. The method as recited in claim 23, wherein the predefinable data value is modifiable via a control input.

25. The method as recited in claim 24, wherein the data of the sensors is collected in a memory device and subsequently transmitted.

26. The method as recited in claim 24, wherein the data of the sensors is in each case subjected to a data reduction algorithm.

27. The method as recited in claim 26, wherein:
the data is transmitted and the sensors communicate with one another and with the control unit one of synchronously and partly asynchronously, and in the case of the partly asynchronous execution the last sensor in the series circuit determines a clock rate.

28. A device, comprising:
a control unit; and
a series circuit of sensors, wherein:
a first sensor includes a transmitting interface and is connected to a sensor interface of a control unit via a first connection,
the first connection is connected to a receiving interface to the transmitting interface of a second sensor via a second connection, and via third and fourth connections, and
additional sensors are connected in series among each other in such a way that the receiving interface is connected to the transmitting interface.
